(19) United States
(12) Patent Application Publication
(10) Pub. No.: US 2006/0282364 A1
(43) Pub. Date: Dec. 14, 2006

(54) Communication system for electrical maintenance management of different facilities and method therefor

(76) Inventor: David A. Berg, Henderson, NV (US)

Correspondence Address: WEISS & MOY PC, 4204 NORTH BROWN AVENUE, SCOTTSDALE, AZ, 85251, US

(21) Appl. No.: 11/151,041

(22) Filed: Jun. 13, 2005

(51) Int. Cl. G06Q 40/00

(52) U.S. Cl. 705/37

(57) ABSTRACT

A communication system and method for monitoring operation of a system in a facility and for sending out repair request has a monitoring device coupled to a system in the facility to be monitored. The monitoring device sends a notification signal when an operational problem is monitored. A receiving device is used for receiving the notification signal sent from the monitoring device. A client communication system is utilized for entering information for a repair order for the operational problem monitored. A repair maintenance server is coupled to the first computer system. The repair maintenance server receives the repair order information and sends bid requests to designated repair vendors. A plurality of vendor computer systems is coupled to the repair maintenance server for repair vendors to submit bids for the repair order. The repair maintenance server will select a vendor and notify the vendor of a winning bid.

### BACKGROUND OF THE INVENTION

1. Field of the Invention

This invention relates generally to maintenance systems, and more specifically, to a communication system and method which will send out work orders to designated maintenance companies for maintenance on electrical, mechanical, plumbing, or other systems of a designated facility.

2. Description of the Prior Art

Reducing operational costs has become a priority for senior management in many business categories (e.g., retail, banking, restaurants, fast food, petroleum, automotive, hospitality, etc.). These retailers have been aggressively seeking cost efficiencies in every sector of their business to improve bottom line financial results. One area of corporate focus is the facility maintenance management sector.

Facility operational efficiency of point-of-purchase displays (POPs), interior and exterior lighting fixtures, as well as interior and exterior electrical signs, and other electrical systems (HVAC and the like) are key focal points for facility managers. When store lighting, POPs and signs are not working correctly, degradation of the stores brand identity and top-of-mind awareness suffers. Overtime, customers tend to redirect their loyalty to more customer friendly and better-maintained stores.

A large amount of time, energy and costs are spent managing vendor issues such as product and labor cost controls, on-site work rules and regulations, schedules, follow-up effort, billing procedures, insurance updates, etc. Another problem that compounds management costs is the constant turnover of approved vendors due to lack of performance and follow-through. This is largely due to the absence of a standard communications platform that both the Clients and Vendors can work within.

Traditionally, stores have used different methods of contracting, controlling, and dispatching maintenance vendors. For example, the following procedures have been used: (1) internal management of vendors by calling to order maintenance on a pay-as-you-go basis; (2) annual local maintenance contracts with vendors that independently perform the work; (3) annual national contracts with regional firms that both perform maintenance and sub-contract maintenance depending on their branch locations and service areas; and (4) annual national contracts with maintenance project management firms that hire vendors throughout the US from their network to perform work and manage them for a fee.

The main purpose for subcontracting out maintenance management services is to reduce internal overhead costs and eliminate the headaches associated with internally managing maintenance Vendors. The end objective of this has been a redirection of management efforts to revenue generating activities.

By reducing internal staff and relying on out-sourced maintenance management, a large reduction of internal overhead is being experienced, but an additional layer of mark-up costs is occurring. In most cases, this process has defeated the basic cost-cutting purpose intended in the first place.

In order to achieve better operational efficiency in maintenance management, better communications and operational standards (along with automatic accountability systems) must be initiated. As companies continue to explore new ways to create cost savings and operational efficiencies, the opportunities for new companies that develop solutions to fill these voids will continue to expand.

Therefore, there is a need for an improved communication system and method for maintenance of electrical, mechanical, plumbing, and other systems of a facility. The improved communication system and method must over come the problems associated with prior art systems and methods. The improved communication system and method will send out work orders to designated maintenance companies for maintenance on systems of a designated facility. The improved communication system and method will have better communications and operational standards, along with automatic accountability systems.

### SUMMARY OF THE INVENTION

In accordance with one embodiment of the present invention, it is an object of the present invention to provide an improved communication system and method for maintenance of electrical, mechanical, plumbing, and other systems of a facility.

It is another object of the present invention to provide an improved communication system and method that over comes the problems associated with prior art systems and methods.

It is still another object of the present invention to provide an improved communication system and method that will send out work orders to designated maintenance companies for maintenance on systems of a designated facility.

It is still another object of the present invention to provide an improved communication system and method that will have better communications and operational standards, along with automatic accountability systems.

### BRIEF DESCRIPTION OF THE EMBODIMENTS

In accordance with one embodiment of the present invention, a communication system for monitoring operation of a system in a facility and for sending out repair request is disclosed. The communication system has a monitoring device coupled to a system in the facility to be monitored. The monitoring device sends a notification signal when an operational problem is monitored. A receiving device is used for receiving the notification signal sent from the monitoring device. A client computer system is utilized for entering information for a repair order for the operational problem monitored. A repair maintenance server is coupled to the first computer system. The repair maintenance server receives the repair order information and sends bid requests to designated repair vendors. A plurality of vendor communication systems is coupled to the repair maintenance server for repair vendors to submit bids for the repair order. The repair maintenance server will select a vendor and notify the vendor of a winning bid.

In accordance with another embodiment of the present invention, a method for monitoring operation of a system in a facility and for sending out repair request is disclosed. The method comprises: sending a notification signal when an operational problem is recorded by a monitoring device on the system in the facility to be monitored; receiving the notification signal sent from the monitoring device; entering information for a repair order on a client computer system for the operational problem monitored; sending the repair order to a repair maintenance server, the repair maintenance server receiving the repair order information and sending bid requests to designated repair vendors; submitting bids in response to the bid requests by the designated repair vendors; and selecting a winning vendor by the repair maintenance server.

The foregoing and other objects, features, and advantages of the invention will be apparent from the following, more particular, descriptions of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a simplified functional block diagram of the communication system of the present invention.

FIG. 2 is a flowchart showing the operation of the communication system.

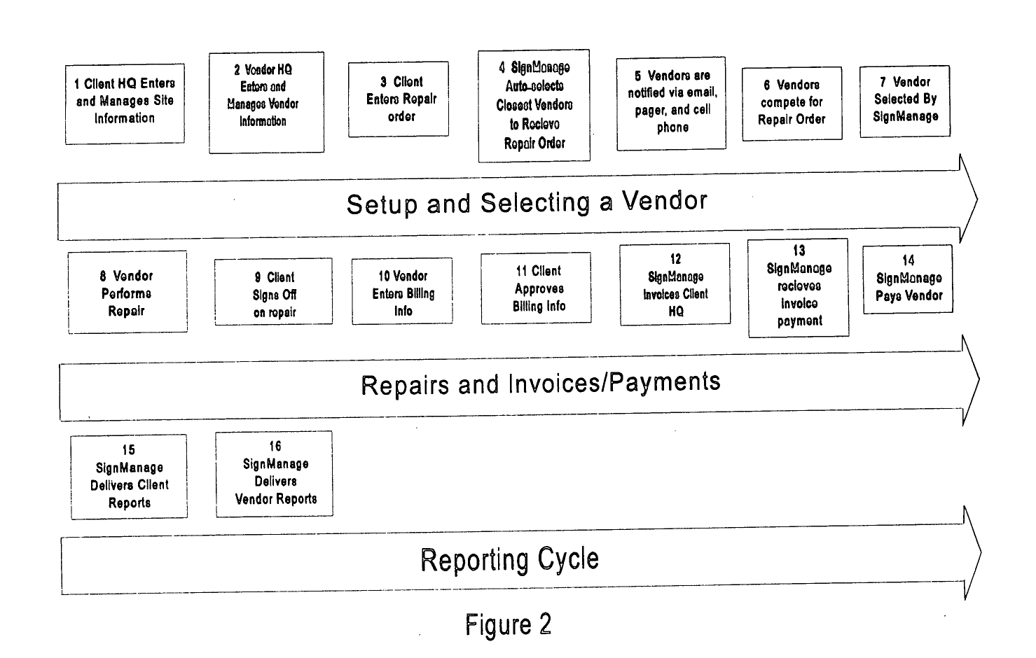

### DETAILED DESCRIPTION OF THE PREFERRED EMBODIMENT

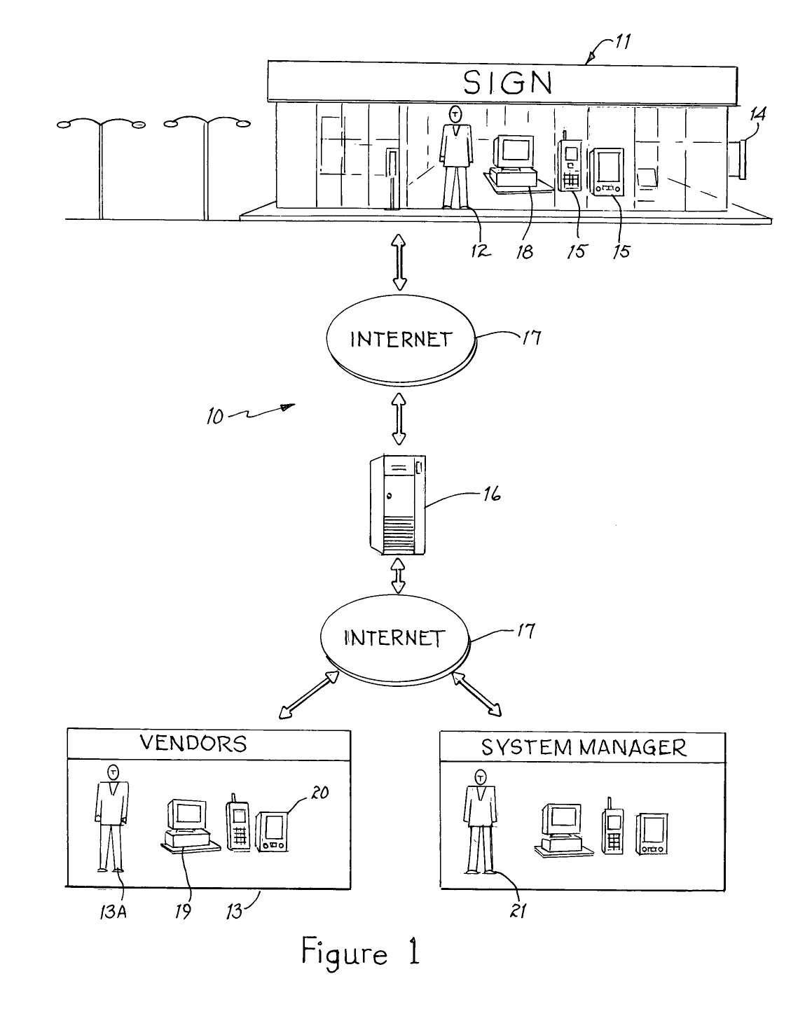

Referring now to the FIG. 1, a communication system 10 is shown. The communication system 10 monitors the operation of systems in a facility 11. If a problem arises, the communication system 10 will signal a designated person 12 in charge of the facility 11. That person 12 will then verify the problem and then enter a request for repairs. The communication system 10 will then send out work orders to designated maintenance companies 13 for maintenance on the system of the designated facility 11. The maintenance companies 13 will then enter a bid for repairing the system. A maintenance company 13 is then selected and will perform the repairs. Alternatively, if a designated maintenance company 13 has been assigned to a designated facility 11, the work order will be sent directly to the designated maintenance company 13 for repairs on the system of the designated facility 11.

The communication system 10 will be described as it relates to an electrical system in a facility. However, it should be understood that the communication system 10 may be used with other types of systems in the facility such as plumbing, gas, mechanical, heating/ventilation/air condition (HVAC), and the like. The listing of the above systems should not be seen as to limit the scope of the present invention. The communication system 10 has a monitoring device 14. The monitoring device 14 is coupled to an electrical system to be monitored. The monitoring device 14 is able to determine if there is a problem in the electrical system being monitored. For example, the monitoring device 14 is able to monitor a lighting system to determine if one or more light bulbs in the lighting system or in a sign is not operating properly or is burned out. The above is given as an example, and should not be seen as to limit the scope of the present invention. The monitoring device 14 is able to monitor other functions without departing from the spirit and scope of the present invention.

If the monitoring device 14 detects a problem, the monitoring device 14 will send a signal to the designated person 12 at the facility 11. The signal may be a wireless signal, a wired signal, or the like. The designated person 12 will receive the signal via a notification device 15. The notification device 15 may be a wired device like a wired telephone or a wireless device like a pager, cellular phone, wireless Personal Digital Assistant (PDA), or the like. Again, the listing of the above devices is given as examples and should not be seen as to limit the scope of the present invention. The designated person 12 can then check out the electrical system to verify the problem.

If a problem in the electrical system being monitored exists, a person 12 will then log on to the maintenance request website hosted by the maintenance request server 16. One will generally log on to the maintenance request website using a computer system 18. It should be noted that one may access the maintenance request website in other ways as well. For example, one may access the maintenance request website through a Personal Digital Assistant (PDA), cellular phone, or other types of wired or wireless communication devices.

The computer system 18 may gain access to the maintenance request website in different manners. For example, one may dial directly into the maintenance request website. Alternatively, one may access the maintenance request website via the Internet 17. Other means of accessing the maintenance request website may be done without departing from the spirit and scope of the present invention.

Once access is gained to the maintenance request website, one will enter information for a repair order request. The repair order request information will include the company name, location of the facility 11, contact person, description of the problem, device specification, and a priority for the repair. Additional information may further be entered without departing from the spirit and scope of the present invention.

After the information is entered, the maintenance request server 16 will send the repair order request to a plurality of different maintenance companies (hereinafter vendors) 13. All the vendors 13 will be rated. Each vendor 13 will be placed into one of three categories: Primary, Secondary and Standby. If a rating of a vendor 13 falls below a certain minimal value, that vendor 13 will fall to the bottom of the queue. The maintenance request server 16 may be programmed to notify a vendor 13 when the vendor 13 falls below the minimal value. In general, the maintenance request server 16 will send the repair order request first to the primary vendors 13. If not enough primary vendors 13 are available, the maintenance request server 16 will send the repair order request to secondary vendors 13. Again, if not enough primary or secondary vendors 13 are available; the maintenance request server 16 will send the repair order request to stand-by vendors 13.

The maintenance request server 16 will send the repair order request to different vendors 13 based on geo-coding. Geo-coding will find all the vendors 13 within a predefined radius of the facility 11. The maintenance request server 16 will then send the repair order request to simultaneously to these vendors 13. Any vendor 13 located outside of the predefined radius of the facility will generally not be sent the repair order request. However, if only 1 or 2 vendors or no vendor 20 is within the predefined radius, the repair order may be sent to vendors 13 outside the predefined radius.

The repair order request will be sent to the designated vendors 13 simultaneously. The maintenance request server 16 can send the repair order request via a wired system or a wireless system. A wired system may be a telephonic system where the maintenance request server 16 would send multiple wired phone calls simultaneously to the designated vendors 13 or a wired internet system where emails are sent simultaneously to the designated vendors 13. A wireless system may be a text messaging, pager system, wireless phone calls, etc. where messages are sent wirelessly and simultaneously to the designated vendors 13. It should be noted that the above are given as examples and should not be seen as to narrow the scope of the present invention.

After the maintenance request server 16 sends the repair order request to the designated vendors 13, the vendors 13 are responsible to submit a quote and/or reply, and a time frame for the repair. Quotes must be submitted by a desired time frame based on the priority designated by the designated person 12 in the facility 11. For example, if the priority is an “Emergency”, vendors 13 need to respond within one hour. If the priority is “One Day” priority, vendors 13 need to reply within six hours. A “Two Day” priority, vendors 13 need to reply within twelve hours. A “Three Day” priority, vendors 13 need to reply within twenty-four hours. The above are given as examples and should not be seen as to limit the scope of the present invention. If no vendors 13 respond within a desired time frame, the maintenance request server 16 will automatically place a follow-up phone call, email, or other means of communication to a contact person 13A associated with each of the designated vendors 13.

Each of the designated vendors 13 will compete for the repair order request. One of the designated vendors 13 will then automatically be selected. Selection may be done in a plurality of different manners. In accordance with one embodiment of the present invention, the maintenance request server 16 will select the designated vendor 13 that responds first to the repair order request. The designated vendor 13 that responds first to the repair order request will be notified by the maintenance request server 16 that their company is now responsible to handle the repair order request based on the pre-approved time frame. The maintenance request server 16 will also notify the designated person 12 in the facility 11 which vendor 13 is responsible for the repairs and the schedule for the repairs.

Alternatively, the maintenance request server 16 may be designed to select the designated vendor 13 that submits the lowest bid. Thus, the designated vendor 13 that submits the lowest bid is the one to handle the repair order request. The bidding process could be a one bid process where the designated vendors 13 will each submit a single bid and the lowest bid will be awarded the repair order request. The bidding process could also be more like an auction. Each of the designated vendors 13 would be given a certain time frame to submit a bid. Once a bid is submitted, it is entered. A designated vendor 13 may change the bid, but only to a lower bid. The designated vendor 13 who submitted the lowest bid at the end of the time frame will be awarded the repair order request. The bidding system may be an open bidding system. An open bidding system allows all the vendors 13 to see the different bids. Alternatively, a blind bidding system may be used where bids cannot be seen by the other vendors 13.

The selection process may be dictated by the maintenance request server 16. Alternatively, the selection process may be selectable based on the desire of the person 12 using the communication system 10. Once a vendor 13 is selected by the maintenance request server 16, the vendor 13 will be notified that their company is now responsible to handle the repair order request. The selected vendor 13 must then perform the required repairs in the designated time frame. Once the repairs are completed, the person 12 (or other people responsible for the facility 11 needs to inspect the worked performed and sign off on the repairs made. Before signing off on the repairs made, the person 12 needs to approve/verify the number of workers supplied by the vendors, the hours worked, etc.

In accordance with another embodiment of the present invention, a designated facility 11 may have a designated vendor 13 assigned to the facility 11. In this embodiment, the work order will be sent directly to the designated vendor 13. Once the work order is sent to the designated vendor 13, the designated vendor 13 is responsible for repairs on the system in the facility 11. The work order is not submitted to other vendors for bids. The work order is only submitted to a specific designated vendor 13.

After the client signs off on the repairs, the vendor 13 will enter the billing information into the maintenance request server 16. The billing information may be entered by the vendor 13 in a plurality of different manners. The vendor 13 may wait and go back to the office and enter the billing information using a wired system 19 such as a computer coupled to the Internet vie a phone, cable, DSL, or other type of line. Alternatively, the vendor 20 can enter the billing information on site using a wireless system 20. For example, the vendor could enter the billing information using a wireless device like a PDA, cellular phone, notebook computer having wireless communication technology (i.e., wireless communication card, built-in wireless communication technology, etc.)

After the vendor 13 enters the billing information, the billing information is sent to the maintenance request server 16. The maintenance request server 16 will receive the billing information, and will prepare an invoice for the work performed by the vendor 13. The maintenance request server 16 will then send out the invoice. The invoice may be sent out in a plurality of different manners. The invoice may be printed out and sent via regular mail. Alternatively, the invoice may be sent out electronically.

The invoice may be sent either directly to the facility 11 that requested the repairs. The facility 11 will then pay the invoice to the account manager 21 running the maintenance request server 16. Once payment is received, the account manager 21 running the maintenance request server 16 will pay the requisite vendor 13. Alternatively, if the facility 11 is part of a chain of stores, the invoice may be sent as part of a corporate invoice for all services performed during a desired time frame for all stores belonging to the corporation. The corporate invoice is then sent to an accounts payable group of the corporation.

The facility 11 may be asked to fill in questions related to the problem handled, quality of the service, and the like. The maintenance request server 16 can have the person 12 fill in a questionnaire when the client reviews the invoice or any time after the vendor 13 has finished the maintenance request order. If questionnaires are filled out, the company running the maintenance request server 16 may then send out the quality reports to the vendor 13.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A communication system for monitoring operation of systems in a facility and for sending out repair request comprising:
a monitoring device coupled to a system in the facility to be monitored, the monitoring device sending a notification signal when an operational problem is monitored;
a receiving device for receiving the notification signal sent from the monitoring device;
a client computer system for entering information for a repair order for the operational problem monitored;
a repair maintenance server coupled to the first computer system, the repair maintenance server receiving the repair order information and sending bid requests to designated repair vendors; and
a plurality of vendor communication systems coupled to the repair maintenance server for repair vendors to submit bids for the repair order;
wherein the repair maintenance server will select a winning vendor and notify the winning vendor of a winning bid.

2. A communication system for monitoring operation of systems in a facility and for sending out repair request in accordance with claim 1 wherein the receiving device for receiving the notification signal sent from the monitoring device is in one of a wireless or wired communication with the monitoring device.

3. A communication system for monitoring operation of systems in a facility and for sending out repair request in accordance with claim 1 further comprising a plurality of vendor receiving devices for simultaneously receiving the bid requests sent by the repair maintenance server.

4. A communication system for monitoring operation of systems in a facility and for sending out repair request in accordance with claim 4 wherein plurality of vendor communication systems are used as the plurality of vendor receiving devices.

5. A communication system for monitoring operation of systems in a facility and for sending out repair request in accordance with claim 4 wherein the plurality of vendor receiving devices are in one of wireless or wired communication with the repair maintenance server for receiving the bid requests sent by the repair maintenance server.

6. A communication system for monitoring operation of systems in a facility and for sending out repair request in accordance with claim 1 wherein the repair maintenance server sends bid requests to designated repair vendors within a predefined radius of the facility.

7. A communication system for monitoring operation of systems in a facility and for sending out repair request in accordance with claim 6 wherein the repair maintenance server sends bid requests to designated repair vendors within a predefined radius of the facility using geo-coding.

8. A communication system for monitoring operation of systems in a facility and for sending out repair request in accordance with claim 1 wherein the repair maintenance server sends an invoice to one of the facilities after the repair request has been completed or a corporate accounts group after the repair request has been completed.

9. A communication system for monitoring operation of systems in a facility and for sending out repair request in accordance with claim 1 wherein the repair maintenance server sends a report to a system manager indicating a quality of service for work performed by winning vendor.

10. A communication system for monitoring operation of systems in a facility and for sending out repair request in accordance with claim 5 wherein the plurality of vendor receiving devices are in one of wireless or wired communication with the repair maintenance server for the vendor to enter billing information.

11. A communication system for monitoring operation of systems in a facility and for sending out repair request in accordance with claim 3 further comprising a plurality of vendor billing devices in one of wireless or wired communication with the repair maintenance server for the vendor to enter billing information.

12. A communication system for monitoring operation of systems in a facility and for sending out repair request in accordance with claim 1 wherein the plurality of vendor communication systems are used for the vendor to enter billing information.

13. A communication system for monitoring operation of systems in a facility and for sending out repair request in accordance with claim 1 wherein the repair maintenance server notifies the facility of the winning vendor.

14. A method for monitoring operation of a system in a facility and for sending out repair request comprising:
sending a notification signal when an operational problem is recorded by a monitoring device on the system in the facility to be monitored;
receiving the notification signal sent from the monitoring device;
entering information for a repair order on a client computer system for the operational problem monitored;
sending the repair order to a repair maintenance server, the repair maintenance server receiving the repair order information and sending bid requests to designated repair vendors;
submitting bids in response to the bid requests by the designated repair vendors; and
selecting a winning vendor by the repair maintenance server.

15. The method of claim 14 further comprising notifying the winning vendor of winning bid.

16. The method of claim 14 wherein the repair maintenance server selecting the winning vendor on a first response basis.

17. The method of claim 14 wherein the repair maintenance server selecting the winning vendor on a lowest bid basis.

18. The method of claim 15 further comprising:
entering billing information into the repair maintenance server after completing the repair order; and
preparing an invoice through the repair maintenance server.

19. The method of claim 18 further comprising sending payment to the winning vendor after receiving payment on the invoice.

20. The method of claim 18 further comprising preparing vendor review by the facility through the repair maintenance server, wherein the vendor review is used for ranking the vendors.

21. The method of claim 13 further comprising notifying the facility of the winning vendor.
